(19) United States
(12) Patent Application Publication
(10) Pub. No.: US 2024/0020620 A1
(43) Pub. Date: Jan. 18, 2024

(54) COMPUTER GENERATED DIGITAL MODELING FOR PRODUCT DELIVERY TECHNIQUE

(71) Applicant: International Business Machines Corporation, Armonk, NY (US)

(72) Inventors: Randy A. Rendahl, Raleigh, NC (US); Martin G. Keen, Cary, NC (US); Jeremy R. Fox, Georgetown, TX (US); Sarbajit K. Rakshit, Kolkata (IN)

(21) Appl. No.: 17/812,046

(22) Filed: Jul. 12, 2022

(51) Int. Cl. G06Q 10/08

(52) U.S. Cl. CPC G06Q 10/0832; G06Q 10/0835

(57) ABSTRACT

A digital model can be generated to determine alternative techniques for product delivery to a customer. A computer can receive data which includes a customer initiated request for delivery of a product from a seller having a seller delivery system with seller delivery capabilities, and the customer having a customer delivery system with one or more delivery capabilities. The customer delivery system and the customer delivery capabilities can be analyzed, including seller delivery system and seller delivery capabilities for transport specifications. A delivery plan can be determined for delivery of the product in response to the transport specifications, and the delivery plan can include one or more delivery modes of transportation of the product.

### BACKGROUND

The present disclosure relates to generating digital computer modeling to determine alternative techniques for product delivery to a customer.

In a typical example of a product order by a customer, a customer can order products online from a seller, and a seller delivery system can deliver the ordered product(s) to the customer. The delivery system can identify an appropriate seller location and can deliver the product to the customer's location. The delivery system can identify an appropriate delivery vehicle, a mode of delivery, and can deliver the product to customer's location. While delivering the product(s) to a customer's location, the delivery system can perform various interaction(s) with the customer, for example, if the customer can pick the product from a store or is the shipment midway through the shipping on a delivery vehicle, or the delivery system can deliver to a customer's home.

### SUMMARY

The present disclosure recognizes the shortcomings and problems associated with current techniques for generating digital modeling to determine alternative techniques for product delivery to a customer. The present invention can include generating digital modeling to determine a best mode or techniques for delivery of a product to a customer based on the customers package receiving capabilities. Such digital modeling can include or be part of a cognitive analysis of examining data regarding a seller delivery capabilities and a customer's package receiving capabilities.

In one example, there can be different levels of priorities for different ordered products by a customer. For some products, a delay in delivery may not have any impact, but for some products early delivery may be preferred because of different level of urgency. In this scenario, a customer may not know the earliest possible delivery day and time, and the delivery system may not detect if the delivery capability can be improved to an earlier possible delivery to the customer. The delivery system may only consider the capability of the delivery system to provide the earliest possible delivery timeline, and not consider other parameters such as customer controlled factors.

In an aspect according to the present invention, a computer-implemented method for generating a digital model to determine alternative techniques for product delivery to a customer can include receiving data, at a computer, the received data including a customer initiated request for delivery of a product from a seller having a seller delivery system with seller delivery capabilities. The request can include a delivery location, and the customer having a customer delivery system with one or more delivery capabilities. The method can include analyzing the customer delivery system and the customer delivery capabilities, and the seller delivery system and seller delivery capabilities for transport specifications, the transport specifications including one or more modes of transportation. The method can include determining a delivery plan for delivery of the product in response to the transport specifications, the delivery plan including one or more delivery modes of transportation for the product. The method can include communicating the delivery plan to the seller delivery system and the customer delivery system. The method can include implementing coordination of the seller delivery system and the customer delivery system according to the delivery plan and in response to the communication of the delivery plan, to deliver the product to the customer.

In a related aspect, the method can further include receiving the delivery plan at the seller delivery systems and the customer delivery system; and delivering the product to the delivery location based on the delivery plan.

In a related aspect, the customer delivery system can include an autonomous vehicle.

In a related aspect, the delivery plan can include utilizing the autonomous vehicle to transport at least a first portion of the product.

In a related aspect, the delivery plan can include using the customer delivery system for at least part of the delivery of the product; and using the seller delivery system for at least part of the delivery of the product.

In a related aspect, the method can further include generating a digital twin model of the delivery plan using the received data.

In a related aspect, the method can include generating a digital twin model, using the computer, of the delivery plan using the received data, the model including the following; updating the received data; updating the analysis of the customer delivery system and the customer delivery capabilities; updating the determining of the delivery plan for delivery of the product in response to the transport specification; and updating the communicating of the delivery plan to the seller delivery system and the customer delivery system.

In a related aspect, the method can further include iteratively generating the digital twin model to produce updated models.

In another aspect according to the present invention, a system for generating a digital model to determine alternative techniques for product delivery to a customer, can include: a computer system comprising; a computer processor, a computer-readable storage medium, and program instructions stored on the computer-readable storage medium being executable by the processor, to cause the computer system to perform the following functions to; receive data, at a computer, the received data including a customer initiated request for delivery of a product from a seller having a seller delivery system with seller delivery capabilities, the request including a delivery location, and the customer having a customer delivery system with one or more delivery capabilities; analyze the customer delivery system and the customer delivery capabilities, and the seller delivery system and seller delivery capabilities for transport specifications, the transport specifications including one or more modes of transportation; determine a delivery plan for delivery of the product in response to the transport specifications, the delivery plan including one or more delivery modes of transportation for the product; communicate the delivery plan to the seller delivery system and the customer delivery system; and implement coordination of the seller delivery system and the customer delivery system according to the delivery plan and in response to the communication of the delivery plan, to deliver the product to the customer.

In a related aspect, the system can further include receiving the delivery plan at the seller delivery systems and the customer delivery system; and delivering the product to the delivery location based on the delivery plan.

In a related aspect, the customer delivery system can include an autonomous vehicle.

In a related aspect, the delivery plan can include utilizing the autonomous vehicle to transport at least a first portion of the product.

In a related aspect, the delivery plan includes: using the customer delivery system for at least part of the delivery of the product; and using the seller delivery system for at least part of the delivery of the product.

In a related aspect, the system can include generating a digital twin model of the delivery plan using the received data.

In a related aspect, the system can further include: generating a digital twin model, using the computer, of the delivery plan using the received data, the model including the following; updating the received data; updating the analysis of the customer delivery system and the customer delivery capabilities; updating the determining of the delivery plan for delivery of the product in response to the transport specification; and updating the communicating of the delivery plan to the seller delivery system and the customer delivery system.

In a related aspect, the system can further include iteratively generating the digital twin model to produce updated models.

In another aspect according to the present invention, a computer program product can generate a digital model to determine alternative techniques for product delivery to a customer. The computer program product can include a computer readable storage medium having program instructions embodied therewith, the program instructions executable by a computer to cause the computer to perform functions, by the computer, comprising the functions to; receive data, at a computer, the received data including a customer initiated request for delivery of a product from a seller having a seller delivery system with seller delivery capabilities, the request including a delivery location, and the customer having a customer delivery system with one or more delivery capabilities; analyze the customer delivery system and the customer delivery capabilities, and the seller delivery system and seller delivery capabilities for transport specifications, the transport specifications including one or more modes of transportation; determine a delivery plan for delivery of the product in response to the transport specifications, the delivery plan including one or more delivery modes of transportation for the product; communicate the delivery plan to the seller delivery system and the customer delivery system; and implement coordination of the seller delivery system and the customer delivery system according to the delivery plan and in response to the communication of the delivery plan, to deliver the product to the customer.

In a related aspect, the computer program product can include: receiving the delivery plan at the seller delivery systems and the customer delivery system; and delivering the product to the delivery location based on the delivery plan.

In a related aspect, the customer delivery system can include an autonomous vehicle.

In a related aspect, the delivery plan can include utilizing the autonomous vehicle to transport at least a first portion of the product.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram graph illustrating a system for generating a digital model to determine alternative techniques for product delivery to a customer, according to an embodiment of the present disclosure.

FIG. 2 is a flow chart illustrating a method according to an embodiment of the present invention, for generating a digital model to determine alternative techniques for product delivery to a customer.

FIG. 3 is a functional schematic block diagram depicting a system for generating a digital model to determine alternative techniques for product delivery to a customer, according to an embodiment of the present disclosure.

FIG. 4 is a flow chart illustrating a method for generating a digital model to determine alternative techniques for product delivery to a customer.

FIG. 5 is a flow chart illustrating another method continuing from the method shown in FIG. 4, according to another embodiment of the present invention.

FIG. 6 is a schematic block diagram depicting a computer system according to an embodiment of the disclosure which may be incorporated, all or in part, in one or more computers or devices shown in other FIGS, and cooperates with the systems and methods shown in the FIGS.

FIG. 7 is a schematic block diagram of a system depicting system components interconnected using a bus. The components for use, in all or in part, with the embodiments of the present disclosure, in accordance with one or more embodiments of the present disclosure.

FIG. 8 is a block diagram depicting a cloud computing environment according to an embodiment of the present invention.

FIG. 9 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method.

It is understood that a customer can be an individual, or a group of individuals, or a company or an organization.

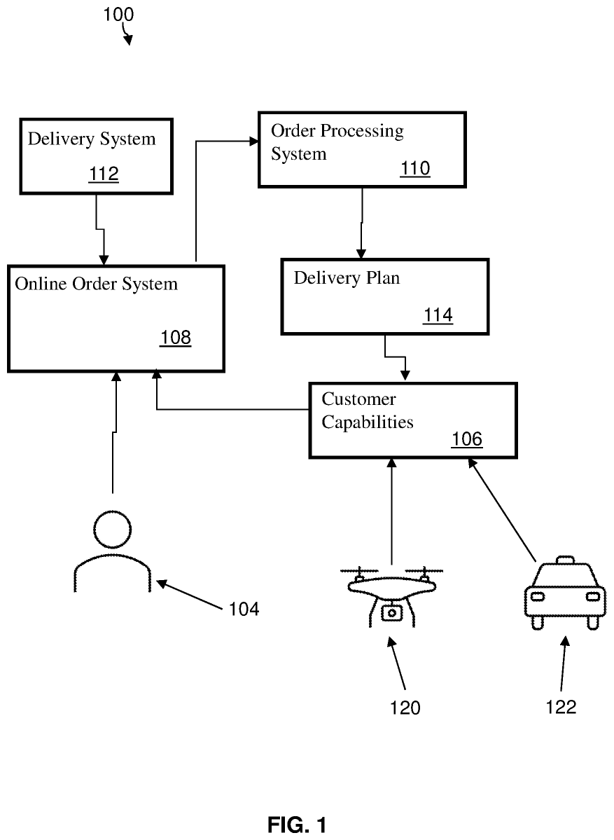

Referring to FIG. 1, a customer 104 can specify a customer capability 106 while ordering a product on an online order system 108 so that the product can be delivered to the customer at the earliest time. A delivery system 112 can identify how a customer's capability can be used for delivering the product to the customer. The online order system can communicate with an order processing system 110. The customer's delivery capability can include use of a drone 120 or a car 122. A delivery plan 114 can include customer capabilities 106. The delivery plan can identify appropriate delivery for a customer can receive the product at an earliest time. The customer delivery capability 106 can include for example, a customer's drone or vehicle performing a store pickup, or a customer's drone or vehicle picking up a product form a midway location from a delivery vehicle, or a delivery vehicle delivering the product to the customer at the customer's location. In another example, the customer delivery capability can include a delivery vehicle being assigned a key to deliver the product to a customer's home.

Further, in a first stage, a system can include order placement and logistical delivery calculations which can include the following. While ordering product online, the customer can specify if the customer wants the product to be delivered at the earliest possible time. The delivery system can identify the products which are to be delivered to the customer at the earliest time. The system can validate the delivery system capability to find how fast the product can be delivered to the customer. In a second stage, the system can include a delivery calculation, method, and preference analysis which can include the following. The delivery system can consider the current engagement of various delivery resources, distance to be covered to delivery, and location of seller, etc. The delivery system can calculate how much early delivery is possible for the delivery system to deliver the product. If a customer wants to get the product earlier than a delivery capability-based delivery timeline, then the customer can specify the capability of the customer. The customer can specify what capability the customer has, which can include, for example, a customer's autonomous vehicle, or drone, etc.

Further, in a third stage, the system can include a digital twin simulation of a delivery method as follows. The system can include receiving the digital twin model of the customer specified delivery device(s), such as, autonomous vehicle, drones etc. The delivery system can analyze the digital twin model of the customer specified capabilities. The delivery system can evaluate if the customer specified capabilities are sufficient to receive the package. The delivery system can consider the capability of the delivery system and the customer specified capability to create optimum delivery plan. The system can simulate different types of modes of delivery along with customer specific delivery capability and delivery system specified delivery capability. In a fourth stage, the system can include a delivery method and routing identification. The system can identify the number of products to be delivered to the customer, and the capability of the customer specified capabilities etc. The system can identify what combination of delivery is available to deliver the product in a secure manner and earliest time. The system can evaluate delivery options such as an option of store pickup or a midway pickup of the package by the customer. The delivery system can identify various routes followed by the delivery vehicles to deliver the product to other different customers. The system can identify the shortest possible time for delivering the product to customer location. The system can identify how the customer capability can be used, and can interact with the delivery system capability. The system can communicate the customer capability usage in terms of time (for example, that a vehicle needs to depart for a pickup), duration (for example, a length of time from departure to final delivery), and a selected device(s) allowing the customer to plan other use around the delivery requirement. In a fifth stage, the system can include key assignment and delivery fulfilment as follows. Based on identified types of delivery to a customer location, the delivery system can assign an appropriate key to the customer specified delivery system. The customer capability can interact with the delivery capability and can receive the products. In a sixth stage, a system can include a knowledge corpus which can update for repetitive/iterative usage as follows. The system can setup and maintain a customer profile with current digital profiles for all customer assets. Customer Assets can be kept up to date pertaining to the digital records. The clear digital twins can represent the clear and present representation of the physical equivalent. Capability changes to the assets can be added or subtracted from an asset records.

In one embodiment, a delivery in progress or delivery process amelioration of a system can include a delivery system which can be instructed to query a customer about available capabilities during the delivery process, and allowing a new optimized delivery combination to be identified based on an actual delivery progress and an up-to-date customer capability availability. For instance, each time the shipment (or items in the shipment) arrive or depart a specific location (for example, a final sorting local location of a shipping vendor), the customer can be made aware of the step and may provide potential capabilities that may be utilized at the current or next location. Delays, changes due to weather or equipment, or updated customer capabilities can be addressed throughout the delivery process ensuring the earliest delivery option can be achieved.

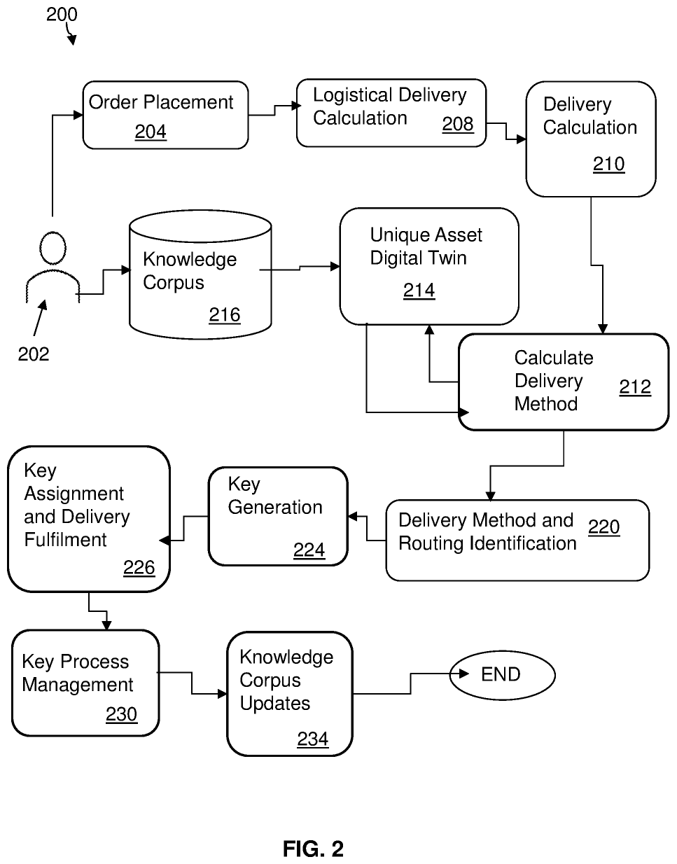

Referring to FIG. 2, in one embodiment according to the present disclosure, a system 200 includes a customer 202 placing an order 204. The customer also has data about delivery capabilities for the customer uploaded into a knowledge corpus 216, which can be referred to a customer delivery enabled assets. The customer may own or have access to autonomous vehicle capability for package receival. If a product is ordered online, and the customer wants to receive the product as early as possible, then the customer can specify the capability of the customer (for example the customer owns a drone, Autonomous vehicle, etc.) which enables receiving the product. Thus, the delivery system can consider both the capability of the sellers delivery system and a customer delivery system to identify how the product can be delivered to the customer at the earliest convenience. The system continues to generate a logistical delivery calculation 208. The system includes a delivery calculation 210, including a method and preference analysis. The knowledge corpus can communicate with a digital twin 214 of unique assets of the customer. The digital twin can be called by a module of the system that calculates a delivery method using the digital twin 212 which can be fed back into the digital twin for iterative updating of a model. The system includes calculating a delivery method and touting identification 220. The system includes generating a key 224 and assigning a key and delivery fulfilment 226. The system includes a key process management 230 which can be inputted into the knowledge corpus for updating the knowledge corpus 234.

In one example, a system according to the present disclosure can select an optimal delivery method (including a user's vehicles). For example, upon receiving the capability of the customer, the delivery system can identifying optimum modes of delivery of the product to the customer, so that customer can receive the product as early as possible. The system can include a customer's drone or vehicle to perform a store pickup. The system can include a rendezvous point where a customer's drone or vehicle can pick the product at a midpoint location from the delivery vehicle. The system can include a delivery vehicle to deliver the product to the customer, or a delivery vehicle can be assigned a key to deliver the product to a customer home or facility.

Additionally, the system can include considering possible equipment availability and capabilities where the delivery system can analyze the capability of the customer's equipment. The carrying capacity can include considering available power, speed, location, etc., and can identify if the customer's capability is sufficient to deliver the product at the earliest, and accordingly the system can plan a phased delivery. The phased deliver can include a partial pickup where a portion of the order can be delivered to the customer's equipment and a remaining portion of the order can be delivered by a delivery vehicle. In another example, the system can split the order into a phased engagement (i.e., multiple pickups) where the customer's equipment can pick up the products in multiple phases, etc.

In another example, key assignment and tracking thereof can include once an optimum delivery is planned, considering customer capability and delivery system capability. If the system considers the customer's capability for delivering to the customer, then the delivery system can assign an appropriate key to the customer's equipment so that customer equipment can interact with delivery systems.

In another example, addition or subtraction of capabilities can include, while ordering product, the customer having the option to specify which customer capabilities can be used, how much capabilities can be used, etc. Accordingly, system can consider the same during delivery of the product to the customer location.

In another example, a system can include customer digital twin to share with a delivery company. The delivery system can generate a digital twin model of the customer's capabilities and accordingly the delivery system can identify appropriate inclusion of customer capabilities regarding the delivery of the product to a customer location at the earliest time.

In general, embodiments according to the present disclosure can include a method to perform delivery utilizing autonomous devices which are in possession of the customer. In another example, a system can establish delivery routes, utilizing customer owned autonomous devices, and derive the logistical capabilities of such a delivery. In another example, a system can include deriving appropriate client owned devices to complete a delivery, and generate a simulation with digital twins to fulfil delivery. In another example, a system can utilize a customer's own autonomous capabilities such as an autonomous drone or vehicle, and subdivide the order based upon desired urgency. In another example, a system can include deriving a customer's own autonomous delivery capabilities, phased engagements, and digital twin modelling. Thus, in another example, a system can include utilizing a digital twin simulation of an autonomous delivery based upon a customer's autonomous capabilities.

Thereby, in another example, a system according to the present disclosure can include utilizing the autonomous capabilities of the customer, not the supplier. When using a customer's autonomous vehicle in place of a supplier's, many differences and variations will exist in capability. A digital twin simulation can address these variants and enable an optional delivery solution tailored to a customer's own autonomous capabilities.

In another example, a method according to the present disclosure can include delivering a product purchased by a buyer from a seller considering buyer provided delivery assistance. The method includes receiving a request to purchase the product from the seller by the buyer with a buyer delivery system and a delivery destination. The buyer delivery system is analyzed along with the product to determine a buyer delivery system utilization assessment as one of applicable or not applicable to transporting the product. An optimal delivery plan is identified based on this analysis and the buyer delivery system utilization assessment. The product is delivered according to an optimal delivery plan. The buyer delivery system can include an autonomous vehicle (e.g., a drone). The optimal delivery plan utilizes the autonomous vehicle to transport at least a first portion of the product. The first portion is integrated with a second portion of the product to form the product wherein the product is transported using a seller delivery system to the destination. The above analysis utilizes a simulation based on a digital twin of the buyer delivery system to determine the buyer delivery system utilization assessment.

In another example, a method according to the present disclosure can include a method for delivering a product purchased by a buyer from a seller considering buyer provided delivery assistance. The method includes receiving a request to purchase the product from the seller by the buyer with a buyer delivery system and a delivery destination. The method includes analyzing the buyer delivery system and the product to determine a buyer delivery system utilization assessment as one of applicable and not applicable to transporting the product. The method includes identifying an optimal delivery plan based on the analyzing and the buyer delivery system utilization assessment, and delivering the product according to the optimal delivery plan.

The method can include the buyer delivery system including an autonomous vehicle (e.g., a drone), or an optimal delivery plan utilizing the autonomous vehicle to transport at least a first portion of the product. The method can include the first portion of the product integrated with a second portion of the product to form the product and the product transported using a seller delivery system to the delivery destination. The method can include utilizing a simulation based on a digital twin of the buyer delivery system to determine the buyer delivery system utilization assessment.

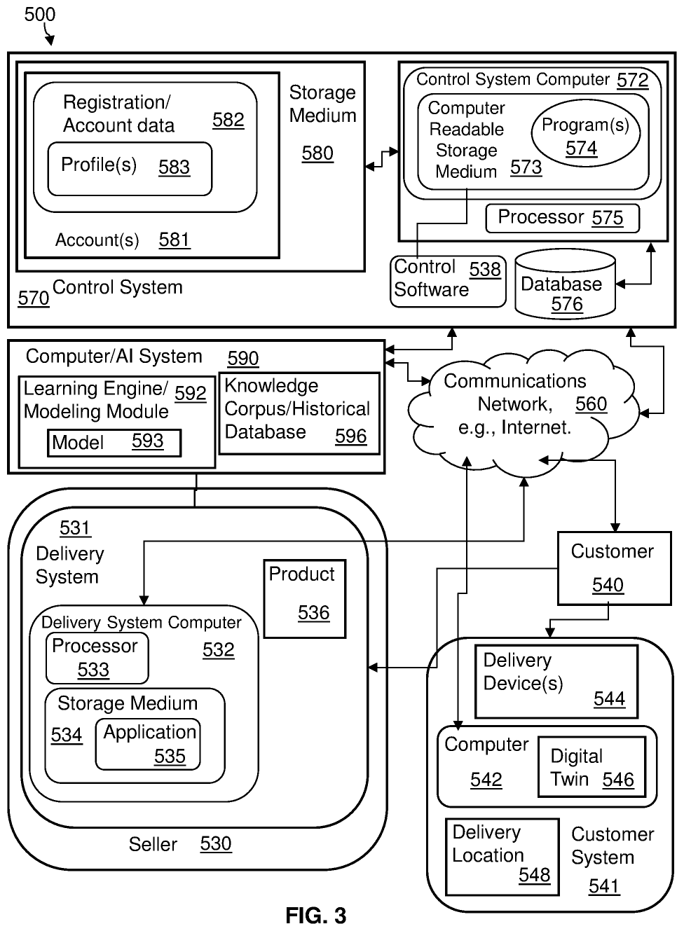

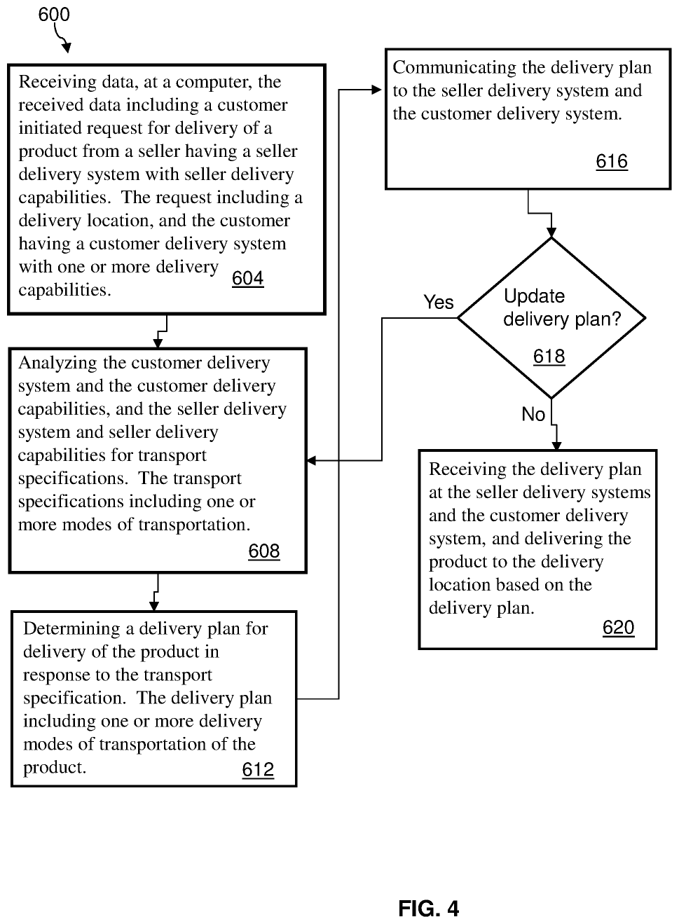

Referring to FIGS. 3 and 4, according to an embodiment of the present disclosure, a system 500 can be used in a computer-implemented method 600 for generating a digital model, for example, a cognitive analysis digital model, to determine alternative techniques for product delivery to a customer can include the following. The method 600 can include receiving data, at a computer 590, as in block 604, where the received data includes a customer initiated request for delivery of a product 536 from a seller 530 having a seller delivery system 531 with seller delivery capabilities, as in block 604. The request includes a delivery location, and the customer 540 having a customer delivery system 541 with one or more delivery capabilities derived from delivery devices 544, such as a drone or a vehicle that enable the customer to assist or be part of the delivery of the product 536. The method includes analyzing the customer delivery system 541 and the customer delivery capabilities, and the seller delivery system 531 and seller delivery capabilities for transport specifications. The transport specifications can include one or more modes of transportation, as in block 608. The method includes determining a delivery plan for delivery of the product in response to the transport specification, and the delivery plan includes one or more delivery modes of transportation of the product, as in block 612. The method includes communicating the delivery plan to the seller 530 delivery system 531 and the customer delivery system 541, as in block 616.

The seller delivery system 531 includes a computer 532 having a processor 533 and computer readable storage medium 534 wherein an application 535 can be embedded. The customer computer 542 can also include a processor, a computer readable storage medium and an application embedded therein. The application can include instructions to communicate with other computer system applications via a network, for example the Internet, and application 535.

When the method updates the delivery plan at block 618, the method returns to block 608. When the delivery plan at block 618 is not updated, the method proceeds to block 620. The method includes receiving the delivery plan at the seller delivery systems and the customer delivery system, and delivering the product to the delivery location based on the delivery plan, as in block 620.

In one example the customer delivery system can include an autonomous vehicle, e.g., a drone. In another example, the delivery plan can include utilizing the autonomous vehicle to transport at least a first portion of the product.

In one example, the delivery plan of the method includes using the customer delivery system for at least part of the delivery of the product; and using the seller delivery system for at least part of the delivery of the product. The method can further include generating a digital twin model of the delivery plan using the received data.

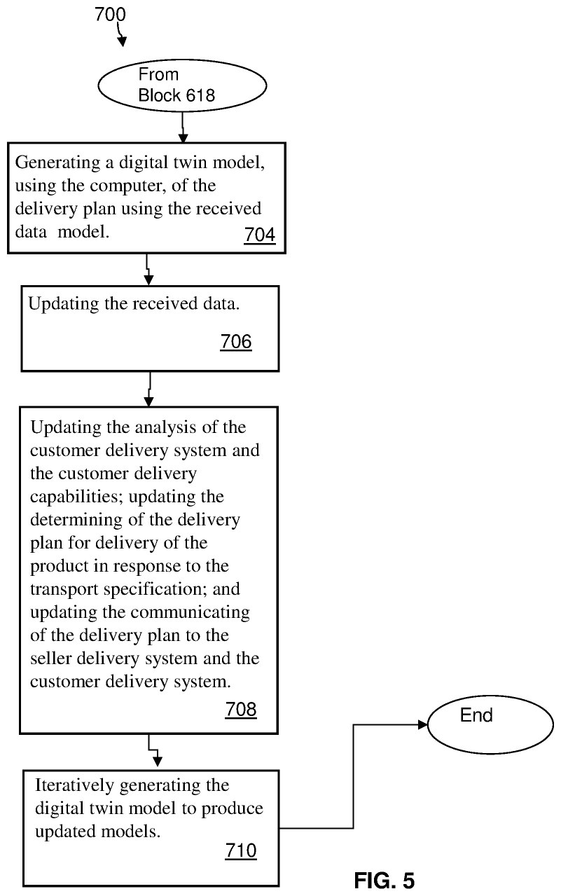

Referring to FIG. 5, in another embodiment according to the present disclosure, a method 700 can continue from block 618 of the method 600 shown in FIG. 4. When the method 600 updates the delivery plan at block 618, the method 700 can include generating a digital twin model, using the computer, of the delivery plan using the received data, as in block 704. The model can include the following. The method includes updating the received data, as in block 706. The method includes updating the analysis of the customer delivery system and the customer delivery capabilities; updating the determining of the delivery plan for delivery of the product in response to the transport specification; and updating the communicating of the delivery plan to the seller delivery system and the customer delivery system, as in block 708. The method can further include iteratively generating the digital twin model to produce updated models, as in block 710.

### Additional Examples and Embodiments

Referring to the figures, and for example, FIG. 3, a system 500 includes a computer 542 which can be integral to or communicating with a device, and communicate with other computers such as computer 532 of the delivery system 531. A computer 590 remote from the delivery system 531 can electronically communicate, in all or in part, with a control system computer 572 as part of a control system 570. The control system can include the computer 572 having a computer readable storage medium 573 which can store one or more programs 574, and a processor 575 for executing program instructions and can also include control software 538 for managing the one or more programs. The control system can also include a storage medium which can include registration and/or account data 582 and profiles 583 of users or entities (such entities can include robotic entities) as part of user accounts 581. User accounts 581 can be stored on a storage medium 580 which is part of the control system 570. The user accounts 581 can include registrations and account data 582 and user profiles 583. The control system can also include the computer 572 having a computer readable storage medium 573 which can store programs or code embedded on the storage medium. The program code can be executed by a processor 575. The computer 572 can communicate with a database 576. The control system 570 can also include a database 576 for storing all or part of such data as described above, and other data.

The control system can also communicate with a computer system 590 which can include a learning engine/module 592 and a knowledge corpus or database 596. The computer system 590 can also communicate with the computer 531 of the device 530 and can be remote from the delivery system computer 532. In another example, the computer system 590 can be all or part of the control system, or all or part of a device. The depiction of the computer system 590 as well as the other components of the system 500 are shown as one example according to the present disclosure. One or more computer systems can communicate with a communications network 560, e.g., the Internet. For example, the computer 590, and the control system 570 can communicate with the communications network 560, and the device/computer 532 can communicate with a local communications network which can communicate with the communications network 560.

In one example, a new or different AI (Artificial Intelligence) ecosystem, or technology/communication or IT (Information Technology) ecosystem can include a local communications network which can communicate with the communications network 560. The system 500 can include a learning engine/module 592, which can be at least part of the control system or communicating with the control system, for generating a model 593 or learning model. In one example, the learning model can model workflow in a new AI or IoT (Internet of Things) ecosystem for machine/devices in the new ecosystem.

In another example, a computer can be part of a device. The computer 532 can include a processor 533 and a computer readable storage medium 534 where an application 535 can be stored which can in one example, embody all or part of the method of the present disclosure. The application can include all or part of instructions to implement the method of the present disclosure, embodied in code and stored on a computer readable storage medium. A device can include a display. The device can operate, in all or in part, in conjunction with a remote server by way of a communications network 560, for example, the Internet.

The method can include an analysis generating a model 593 based on received data. A model can also be generated by an AI system, at least in part. In one example, an AI system can generate a model using an AI system analysis using machine learning.

In other embodiments and examples, in the present disclosure shown in the figures, a computer can be part of a remote computer or a remote server, for example, a remote server. In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs. A device(s), for example a mobile device or mobile phone, can belong to one or more users, and can be in communication with the control system via the communications network.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

Thus, in one example, a control system can be in communication with a computer or device, and the computer can include an application or software. The computer, or a computer in a mobile device can communicate with the control system using the communications network. In another example, the control system can have a front-end computer belonging to one or more users, and a back-end computer embodied as the control system.

Methods and systems according to embodiments of the present disclosure, can be incorporated in one or more computer programs or an application stored on an electronic storage medium, and executable by the processor, as part of the computer on mobile device. For example, a mobile device can communicate with the control system, and in another example, a device such as a video feed device can communicate directly with the control system. Other users (not shown) may have similar mobile devices which communicate with the control system similarly. The application can be stored, all or in part, on a computer or a computer in a mobile device and at a control system communicating with the mobile device, for example, using the communications network, such as the Internet. It is envisioned that the application can access all or part of program instructions to implement the method of the present disclosure. The program or application can communicate with a remote computer system via a communications network (e.g., the Internet) and access data, and cooperate with program(s) stored on the remote computer system. Such interactions and mechanisms are described in further detail herein and referred to regarding components of a computer system, such as computer readable storage media, which are shown in one or more embodiments herein and described in more detail in regards thereto referring to one or more computers and systems described herein.

Also, referring to the figures, a device can include a computer, computer readable storage medium, and operating systems, and/or programs, and/or a software application, which can include program instructions executable using a processor. Embodiments of these features are shown herein in the figures. The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

A control system can include a storage medium for maintaining a registration of users and their devices for analysis of the audio input. Such registration can include user profiles, which can include user data supplied by the users in reference to registering and setting-up an account. In an embodiment, the method and system which incorporates the present disclosure includes the control system (generally referred to as the back-end) in combination and cooperation with a front end of the method and system, which can be the application. In one example, the application is stored on a device, for example, a computer or device on location, and can access data and additional programs at a back end of the application, e.g., control system.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, which may be shown, for example, in the example figures, for instance an application stored on a computer readable storage medium of a computer or device. The application is stored on the device or computer and can access data and additional programs at the back end of the application, for example, in the program(s) stored in the control system.

The program(s) can include, all or in part, a series of executable steps for implementing the method of the present disclosure. A program, incorporating the present method, can be all or in part stored in the computer readable storage medium on the control system or, in all or in part, on a computer or device. It is envisioned that the control system can not only store the profile of users, but in one embodiment, can interact with a website for viewing on a display of a device such as a mobile device, or in another example the Internet, and receive user input related to the method and system of the present disclosure. It is understood that embodiments shown in the figures depicts one or more profiles, however, the method can include multiple profiles, users, registrations, etc. It is envisioned that a plurality of users or a group of users can register and provide profiles using the control system for use according to the method and system of the present disclosure.

In one example, received data can include data in a knowledge corpus and historical database, which can be populated by historical data gathered, for example, from sensors, robotic device, or other machines or devices.

Referring to one or more embodiments in the figures, a computer or a device, also can be referred to as a user device or an administrator's device, includes a computer having a processor and a storage medium where an application can be stored. The application can embody the features of the method of the present disclosure as instructions. The user can connect to a learning engine using the device. The device which includes the computer and a display or monitor. The application can embody the method of the present disclosure and can be stored on the computer readable storage medium. The device can further include the processor for executing the application/software. The device can communicate with a communications network, e.g., the Internet.

It is understood that the user device is representative of similar devices which can be for other users, as representative of such devices, which can include, mobile devices, smart devices, laptop computers etc.

In one example, the system of the present disclosure can include a control system 570 communicating with the delivery system 531 via a communications network 560. The control system can incorporate all or part of an application or software for implementing the method of the present disclosure. The control system can include a computer readable storage medium 580 where account data and/or registration data 582 can be stored. User profiles 583 can be part of the account data and stored on the storage medium 580. The control system can include a computer 572 having computer readable storage medium 573 and software programs 574 stored therein. A processor 575 can be used to execute or implement the instructions of the software program. The control system can also include a database 576.

In another example and embodiment, profiles can be saved for entities such as users, participants, operators, human operators, or robotic devices. Such profiles can supply data regarding the user and history of deliveries for analysis. In one example, a user can register or create an account using the control system which can include one or more profiles as part of registration and/or account data. The registration can include profiles for each user having personalized data. For example, users can register using a website via their computer and GUI (Graphical User Interface) interface. The registration or account data can include profiles for an account for each user. Such accounts can be stored on the control system, which can also use the database for data storage. A user and a related account can refer to, for example, a person, or an entity, or a corporate entity, or a corporate department, or another machine such as an entity for automation such as a system using, in all or in part, artificial intelligence.

Additionally, methods and systems according to embodiments of the present disclosure can be discussed in relation to a functional system(s) depicted by functional block diagrams. The methods and systems can include components and operations for embodiments according to the present disclosure, and is used herein for reference when describing the operational steps of the methods and systems of the present disclosure. Additionally, the functional system, according to an embodiment of the present disclosure, depicts functional operations indicative of the embodiments discussed herein.

### More Examples and Embodiments

The methods and systems of the present disclosure can include a series of operational blocks for implementing one or more embodiments according to the present disclosure. A method shown in the figures may be another example embodiment, which can include aspects/operations shown in another figure and discussed previously, but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants. It is also understood that machine and device are used interchangeable herein to refer to machine or devices in one or ecosystems or environments, which can include, for example and artificial intelligence (AI) environment.

### Still Further Embodiments and Examples

A computer implemented method as disclosed herein can include modeling, using the computer. The model can be generated using a learning engine or modeling module of a computer system which can be all or in part of an Artificial Intelligence (AI) system which communicates with the computer and/or a control system. Such a computer system can include or communicate with a knowledge corpus or historical database. In one example, an acceptable model can include a model meeting specified parameters. In another example, an acceptable model can be a model which has undergone several iterations of modeling. When the model is not acceptable, the method can return to return to a previous operation or proceed as directed, for example as represented by a operational block in a flowchart.

In one example according to the present disclosure, a method can generate a model, using a computer, which can include a series of operations. The model can be generated using a learning engine or modeling module of a computer system which can be all or in part of an Artificial Intelligence (AI) system which communicates with a computer and/or a control system. Such a computer system can include or communicate with a knowledge corpus or historical database.

The model can be generated using a learning engine or modeling module of a computer system which can be all or in part of an Artificial Intelligence (AI) system which communicates with a computer and/or a control system. Such a computer system can include or communicate with a knowledge corpus or historical database. A model can also be generated by an AI system such as an output at least in part of an AI system analysis using machine learning.

### Additional Embodiments and Examples

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items.

In one example a user can register have an account with a user profile on a control system. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### Other Additional Embodiments and Examples

In one example, Artificial Intelligence (AI) can be used, all or in part, for generating a model or a learning model as discussed herein in embodiments of the present disclosure. An Artificial Intelligence (AI) System can include machines, computer, and computer programs which are designed to be intelligent or mirror intelligence. Such systems can include computers executing algorithms. AI can include machine learning and deep learning. For example, deep learning can include neural networks. An AI system can be cloud based, that is, using a cloud-based computing environment having computing resources. In another example, a control system can be all or part of an Artificial Intelligence (AI) system. For example, the control system can be one or more components of an AI system.

It is also understood that methods and systems according to embodiments of the present disclosure, can be incorporated into (Artificial Intelligence) AI devices, components or be part of an AI system, which can communicate with respective AI systems and components, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Further Additional Examples and Embodiments

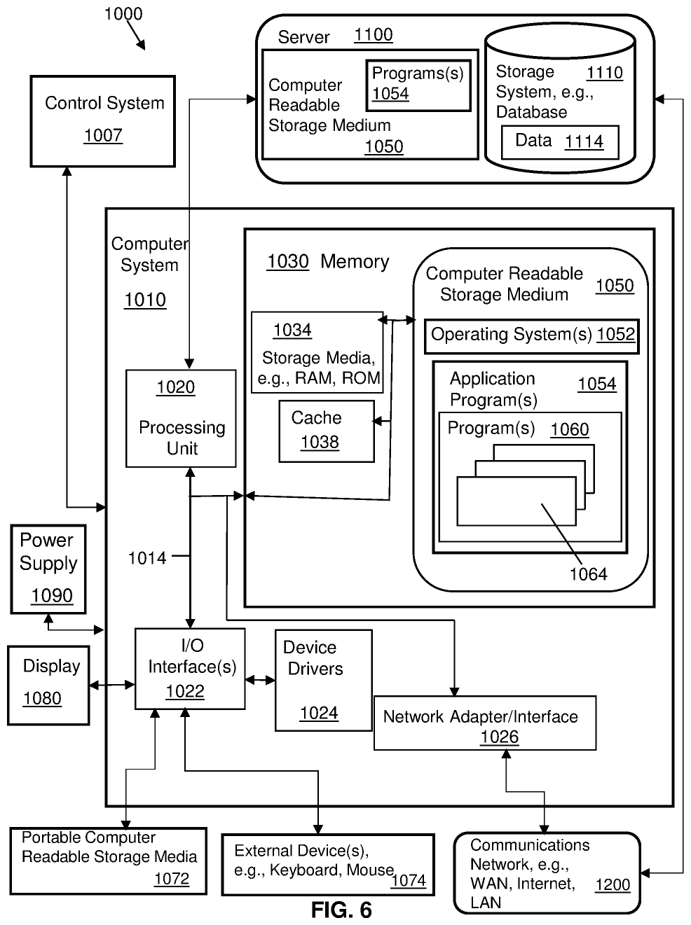

Referring to FIG. 6, an embodiment of system or computer environment 1000, according to the present disclosure, includes a computer system 1010 shown in the form of a generic computing device. The method 100, for example, may be embodied in a program 1060, including program instructions, embodied on a computer readable storage device, or a computer readable storage medium, for example, generally referred to as computer memory 1030 and more specifically, computer readable storage medium 1050. Such memory and/or computer readable storage media includes non-volatile memory or non-volatile storage, also known and referred to non-transient computer readable storage media, or non-transitory computer readable storage media. For example, such non-volatile memory can also be disk storage devices, including one or more hard drives. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that a control system 1007, communicating with a computer system, can include all or part of the computer system 1010 and its components, and/or the control system can communicate with all or part of the computer system 1010 and its components as a remote computer system, to achieve the control system functions described in the present disclosure. The control system function, for example, can include storing, processing, and executing software instructions to perform the functions of the present disclosure. It is also understood that the one or more computers or computer systems shown in other figures can include all or part of the computer system 1010 and its components, and/or the one or more computers can communicate with all or part of the computer system 1010 and its components as a remote computer system, to achieve the computer functions described in the present disclosure. For example, the control system 1007 can be a representation, in all or part, of a control system depicted in other figures herein.

In an embodiment according to the present disclosure, one or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions. For example, in one embedment according to the present disclosure, a program embodying a method is embodied in, or encoded in, a computer readable storage medium, which includes and is defined as, a non-transient or non-transitory computer readable storage medium. Thus, embodiments or examples according to the present disclosure, of a computer readable storage medium do not include a signal, and embodiments can include one or more non-transient or non-transitory computer readable storage mediums. Thereby, in one example, a program can be recorded on a computer readable storage medium and become structurally and functionally interrelated to the medium.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. A power supply 1090 can also connect to the computer using an electrical power supply interface (not shown). Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

### Still Further Additional Examples and Embodiments

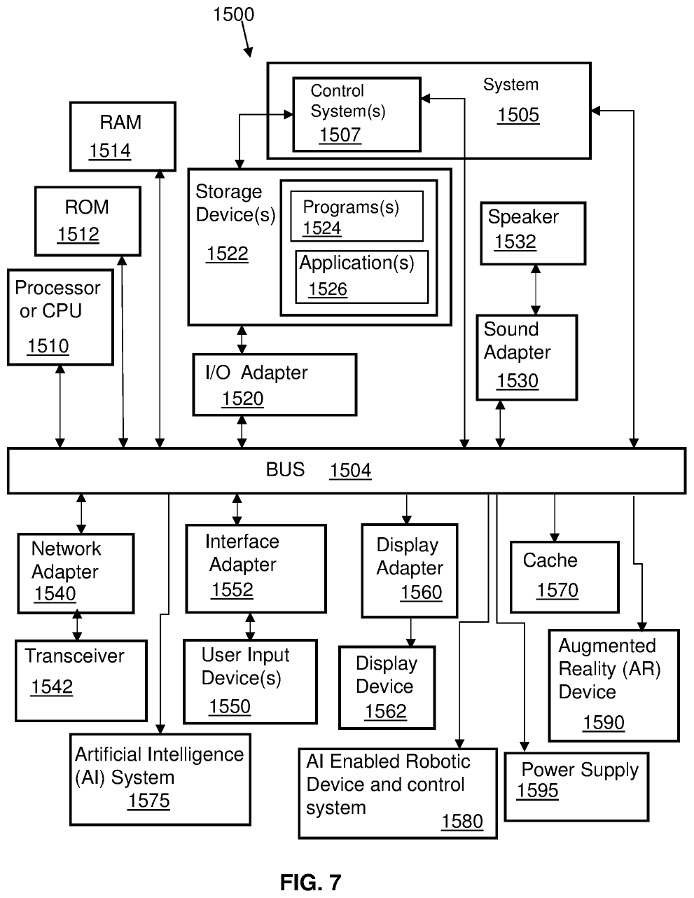

Referring to FIG. 7, an example system 1500 for use with the embodiments of the present disclosure is depicted. The system 1500 includes a plurality of components and elements connected via a system bus 1504. At least one processor (CPU) 1510, is connected to other components via the system bus 1504. A cache 1570, a Read Only Memory (ROM) 1512, a Random Access Memory (RAM) 1514, an input/output (I/O) adapter 1520, a sound adapter 1530, a network adapter 1540, a user interface adapter 1552, a display adapter 1560 and a display device 1562, are also operatively coupled to the system bus 1504 of the system 1500. An AR device 1580 can also be operatively coupled to the bus 1504. An AI enabled robotic device and robot control system 1580 can also be operatively coupled to the bus 1504. Such a robot and robot control system 1580 can incorporate all or part of embodiments of the present disclosure and discussed hereinbefore. An artificial intelligence (AI) system 1575 or an AI ecosystem can also be operatively coupled to the bus 1504. A power supply 1595 can also be operatively connected to the bus 1504 for providing power to components and for functions according to the present disclosure. An augmented reality (AR) device 1590 can also be operatively connected to the bus 1504 for providing augmented reality output to a wearable augmented reality device, such as AR glasses or an AR headset.

One or more storage devices 1522 are operatively coupled to the system bus 1504 by the I/O adapter 1520. The storage device 1522, for example, can be any of a disk storage device (e.g., a magnetic or optical disk storage device), a solid state magnetic device, and so forth. The storage device 1522 can be the same type of storage device or different types of storage devices. The storage device can include, for example, but not limited to, a hard drive or flash memory and be used to store one or more programs 1524 or applications 1526. The programs and applications are shown as generic components and are executable using the processor 1510. The program 1524 and/or application 1526 can include all of, or part of, programs or applications discussed in the present disclosure, as well vice versa, that is, the program 1524 and the application 1526 can be part of other applications or program discussed in the present disclosure.

The system 1500 can include a control system 1507 which is part of the system 1505 and can communicate with the system bus independently or as part of the system 100, and thus can communicate with the other components of the system 1500 via the system bus. In one example, the storage device 1522, via the system bus, can communicate with the control system 170 which has various functions as described in the present disclosure. For example, the control system 1507 and system 1505 can represent, all or in part, a system and a control system as described in other embodiments depicted in the figures and described in further detail hereinbefore.

In one aspect, a speaker 1532 is operatively coupled to system bus 1504 by the sound adapter 1530. A transceiver 1542 is operatively coupled to system bus 1504 by the network adapter 1540. A display 1562 is operatively coupled to the system bus 1504 by the display adapter 1560.

In another aspect, one or more user input devices 1550 are operatively coupled to the system bus 1504 by the user interface adapter 1552. The user input devices 1550 can be, for example, any of a keyboard, a mouse, a keypad, an image capture device, a motion sensing device, a microphone, a device incorporating the functionality of at least two of the preceding devices, and so forth. Other types of input devices can also be used, while maintaining the spirit of the present invention. The user input devices 1550 can be the same type of user input device or different types of user input devices. The user input devices 1550 are used to input and output information to and from the system 1500.

### Other Aspects and Examples

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Additional Aspects and Examples

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

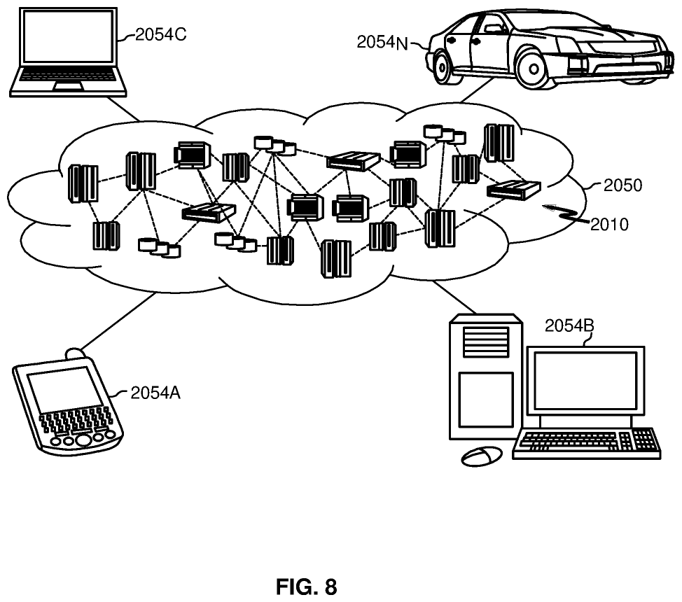

Referring now to FIG. 8, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 8 are intended to be illustrative only and that computing nodes 2010 and cloud computing environment 2050 can communicate with any type of computerized device over any type of network and/or network addressable connection (e.g., using a web browser).

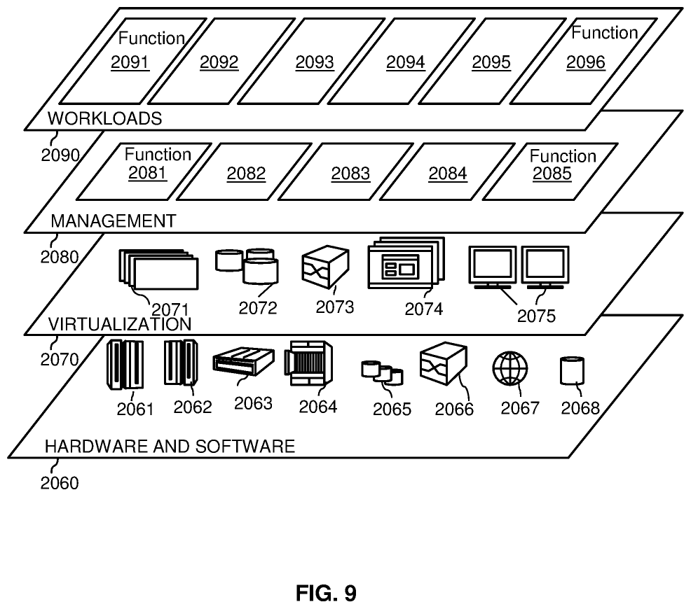

Referring now to FIG. 9, a set of functional abstraction layers provided by cloud computing environment 2050 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and cognitive analytics for digital modeling 2096, for example, digital modeling of customer delivery capabilities combined with a seller delivery system for enhanced product delivery to a customer.

What is claimed is:

1. A computer-implemented method for generating a digital model to determine alternative techniques for product delivery to a customer, comprising:
receiving data, at a computer, the received data including a customer initiated request for delivery of a product from a seller having a seller delivery system with seller delivery capabilities, the request including a delivery location, and the customer having a customer delivery system with one or more delivery capabilities;
analyzing the customer delivery system and the customer delivery capabilities, and the seller delivery system and seller delivery capabilities for transport specifications, the transport specifications including one or more modes of transportation;
determining a delivery plan for delivery of the product in response to the transport specifications, the delivery plan including one or more delivery modes of transportation for the product;
communicating the delivery plan to the seller delivery system and the customer delivery system; and
implementing coordination of the seller delivery system and the customer delivery system according to the delivery plan and in response to the communication of the delivery plan, to deliver the product to the customer.

2. The method of claim 1, further comprising:
receiving the delivery plan at the seller delivery systems and the customer delivery system; and
delivering the product to the delivery location based on the delivery plan.

3. The method of claim 1, wherein the customer delivery system includes an autonomous vehicle.

4. The method of claim 3, wherein the delivery plan includes utilizing the autonomous vehicle to transport at least a first portion of the product.

5. The method of claim 1, wherein the delivery plan includes:
using the customer delivery system for at least part of the delivery of the product; and
using the seller delivery system for at least part of the delivery of the product.

6. The method of claim 1, further comprising:
generating a digital twin model of the delivery plan using the received data.

7. The method of claim 1, further comprising:
generating a digital twin model, using the computer, of the delivery plan using the received data, the model including the following;
updating the received data;
updating the analysis of the customer delivery system and the customer delivery capabilities;
updating the determining of the delivery plan for delivery of the product in response to the transport specification; and
updating the communicating of the delivery plan to the seller delivery system and the customer delivery system.

8. The method of claim 7, further comprising:
iteratively generating the digital twin model to produce updated models.

9. A system for generating a digital model to determine alternative techniques for product delivery to a customer, which comprises:
a computer system comprising; a computer processor, a computer-readable storage medium, and program instructions stored on the computer-readable storage medium being executable by the processor, to cause the computer system to perform the following functions to;
receive data, at a computer, the received data including a customer initiated request for delivery of a product from a seller having a seller delivery system with seller delivery capabilities, the request including a delivery location, and the customer having a customer delivery system with one or more delivery capabilities;
analyze the customer delivery system and the customer delivery capabilities, and the seller delivery system and seller delivery capabilities for transport specifications, the transport specifications including one or more modes of transportation;
determine a delivery plan for delivery of the product in response to the transport specifications, the delivery plan including one or more delivery modes of transportation for the product;
communicate the delivery plan to the seller delivery system and the customer delivery system; and
implement coordination of the seller delivery system and the customer delivery system according to the delivery plan and in response to the communication of the delivery plan, to deliver the product to the customer.

10. The system of claim 9, further comprising:
receiving the delivery plan at the seller delivery systems and the customer delivery system; and
delivering the product to the delivery location based on the delivery plan.

11. The system of claim 9, wherein the customer delivery system includes an autonomous vehicle.

12. The system of claim 11, wherein the delivery plan includes utilizing the autonomous vehicle to transport at least a first portion of the product.

13. The system of claim 9, wherein the delivery plan includes:
using the customer delivery system for at least part of the delivery of the product; and
using the seller delivery system for at least part of the delivery of the product.

14. The system of claim 9, further comprising:
generating a digital twin model of the delivery plan using the received data.

15. The system of claim 9, further comprising:
generating a digital twin model, using the computer, of the delivery plan using the received data, the model including the following;
updating the received data;
updating the analysis of the customer delivery system and the customer delivery capabilities;
updating the determining of the delivery plan for delivery of the product in response to the transport specification; and
updating the communicating of the delivery plan to the seller delivery system and the customer delivery system.

16. The system of claim 15, further comprising:
iteratively generating the digital twin model to produce updated models.

17. A computer program product for generating a digital model to determine alternative techniques for product delivery to a customer, the computer program product comprising a computer readable storage medium having program instructions embodied therewith, the program instructions executable by a computer to cause the computer to perform functions, by the computer, comprising the functions to:
receive data, at a computer, the received data including a customer initiated request for delivery of a product from a seller having a seller delivery system with seller delivery capabilities, the request including a delivery location, and the customer having a customer delivery system with one or more delivery capabilities;
analyze the customer delivery system and the customer delivery capabilities, and the seller delivery system and seller delivery capabilities for transport specifications, the transport specifications including one or more modes of transportation;
determine a delivery plan for delivery of the product in response to the transport specifications, the delivery plan including one or more delivery modes of transportation for the product;
communicate the delivery plan to the seller delivery system and the customer delivery system; and
implement coordination of the seller delivery system and the customer delivery system according to the delivery plan and in response to the communication of the delivery plan, to deliver the product to the customer.

18. The computer program product of claim 17, further comprising:
receiving the delivery plan at the seller delivery systems and the customer delivery system; and
delivering the product to the delivery location based on the delivery plan.

19. The computer program product of claim 17, wherein the customer delivery system includes an autonomous vehicle.

20. The computer program product of claim 19, wherein the delivery plan includes utilizing the autonomous vehicle to transport at least a first portion of the product.
